(19) United States
(12) Patent Application Publication
(10) Pub. No.: US 2006/0045521 A1
(43) Pub. Date: Mar. 2, 2006

(54) High-power, multiple output amplifier in a passive optical network

(76) Inventors: Clayton J. Emery, Davie, FL (US); Richard B. Joerger, Davie, FL (US)

Correspondence Address: LAW OFFICES OF MARK C. PICKERING, P.O. BOX 300, PETALUMA, CA, 94953, US

(21) Appl. No.: 10/927,337

(22) Filed: Aug. 26, 2004

(51) Int. Cl. H04J 14/00

(52) U.S. Cl. 398/45

(57) ABSTRACT

The service disruptions that are caused when a high-power, multiple output amplifier is turned off to allow downstream sections of a fiber optic cable or optical equipment to be safely removed for repair or cleaning is substantially reduced by utilizing a number of switches that can pass a modulated light beam under normal conditions, or remove the light beam when maintenance is required.

### BACKGROUND OF THE INVENTION

1. Field of the Invention

The present invention relates to a passive optical network (PON) and, more particularly, to a high-power, multiple output amplifier in a PON.

2. Description of the Related Art

A Fiber-To-The-Home (FTTH) passive optical network (PON) is a system that terminates a fiber optic cable in an optical network terminal (ONT) positioned at an interior or exterior location on a subscriber's premise. As a result, a substantial amount of bandwidth can be made available to the subscriber to provide a variety of services, such as plain old telephone service (POTS), Internet access service, and television service.

FIG. 1 shows a circuit diagram that illustrates a portion of a prior-art FTTH PON 100. As shown in FIG. 1, PON 100 includes a high-power, multiple output amplifier 110 that receives a modulated laser beam MLB either directly or indirectly from an optical line terminal (OLT), amplifies and splits the modulated laser beam MLB into a number of amplified modulated laser beams ALB1-ALBn, and outputs the amplified modulated laser beams ALB1-ALBn.

As further shown in FIG. 1, amplifier 110 includes an erbium-doped fiber amplifier (EDFA) 112 that directly amplifies the modulated laser beam MLB. EDFA 112 utilizes a short length of optical fiber that has been doped with the rare-earth element erbium. When the modulated laser beam MLB passes through the short length of optical fiber, external energy is applied, such as at infrared (IR) wavelengths.

The external energy excites the atoms in EDFA 112 which, in turn, increases the intensity of the modulated laser beam MLB to output an intensified modulated laser beam AMB. As a result, EDFA 112 maintains the modulation of the modulated laser beam MLB while at the same time increasing the brightness of the modulated laser beam MLB to output the intensified modulated laser beam AMB.

In addition to EDFA 112, amplifier 110 includes an optical splitter 114 that receives the intensified modulated laser beam AMB, and then splits the intensified modulated laser beam AMB to output the amplified modulated laser beams ALB1-ALBn. Thus, amplifier 110 amplifies the intensity of the modulated laser beam MLB, and then splits and outputs a number of laser beams.

As further shown in FIG. 1, in addition to amplifier 110, PON 100 also includes a corresponding number of optical fiber sections OF1-OFn that pass the amplified modulated laser beams ALB1-ALBn, and a corresponding number of local splitters SP1-SPn. The local splitters SP1-SPn receive the amplified modulated laser beams ALB1-ALBn from the optical fiber sections OF1-OFn, split the amplified modulated laser beams ALB1-ALBn to form a number of split laser beams SLB1-SLBm, and output the split laser beams SLB1-SLBm. For example, each local splitter SP can output up to 32 split laser beams SLB.

PON 100 further includes a corresponding number of local fiber sections LF1-LFm that are connected to the local splitters SP1-SPn to carry the split laser beams SLB1-SLBm, and corresponding number of ONTs ONT1-ONTm that are connected to the local fiber sections LF1-LFm to receive the split laser beams SLB1-SLBm at the subscribers' premises.

One problem with amplifier 110 is the loss of service that occurs when maintenance must be performed to repair or clean one of the optical fiber sections OF1-OFn or the associated equipment. For example, when maintenance must be performed to optical fiber section OF1, a maintenance technician first turns off amplifier 110 to remove power (the laser beam) from optical fiber section OF1. Once power has been removed, optical fiber section OF1 can be safely removed from amplifier 110.

However, when amplifier 110 is turned off to remove power from optical fiber section OF1, power is also removed from the remaining optical fiber sections OF2-OFn that are connected to amplifier 110, thereby causing the loss of service to every subscriber whose signal passes through amplifier 110.

If maintenance is attempted without first removing power from amplifier 110, inadvertent mishandling of the fiber or equipment can expose the technician's eyes to optical energy which can damage the technician's eyes. If the intensity of the optical energy is reduced to reduce the possibility of inadvertent eye damage, additional amplifiers must be added between the OLT and the subscribers' premises which, in turn, significantly increases the cost to install and maintain the PON.

### BRIEF DESCRIPTION OF THE DRAWINGS

FIG. 1 is a circuit diagram illustrating a portion of a prior-art FTTH PON 100.

FIG. 2 is a circuit diagram illustrating an example of a portion of a FTTH PON 200 in accordance with the present invention.

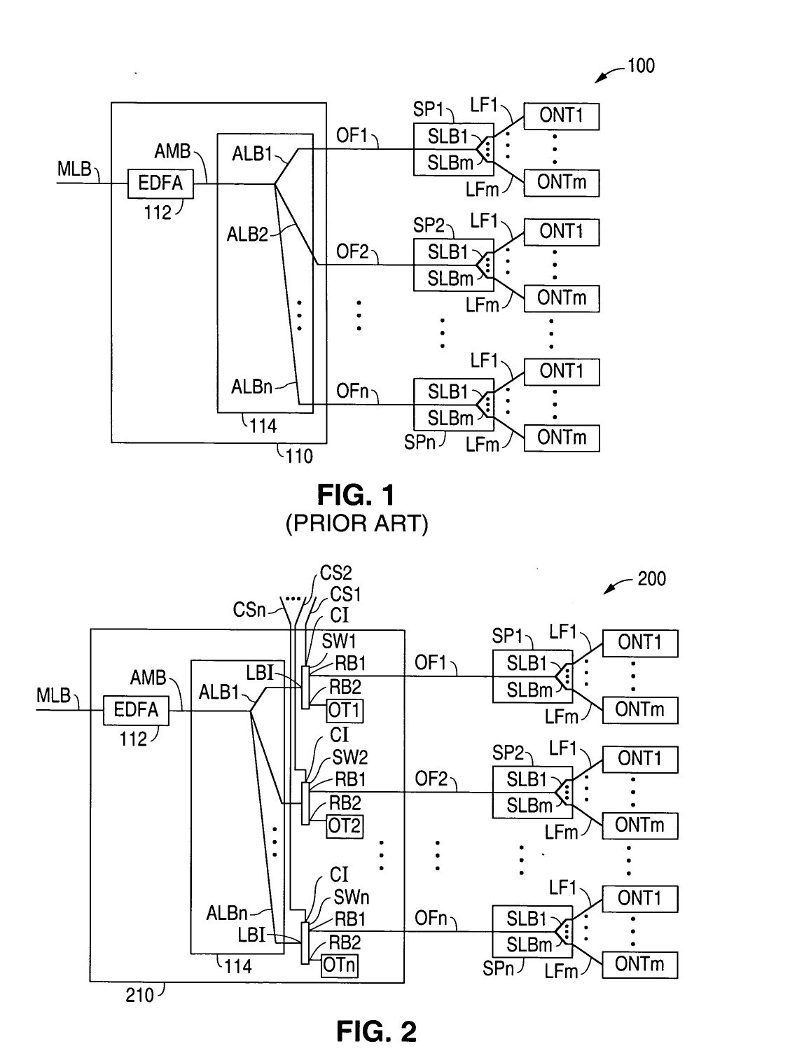

### DETAILED DESCRIPTION OF THE INVENTION

FIG. 2 shows a circuit diagram that illustrates an example of a portion of a FTTH PON 200 in accordance with the present invention. PON 200 is similar to PON 100 and, as a result, utilizes the same reference numerals to designate the structures which are common to both passive optical networks.

As shown in FIG. 2, PON 200 differs from PON 100 in that PON 200 utilizes a high-power, multiple output amplifier 210 in lieu of high-power, multiple output amplifier 110. As with amplifier 110, high-power multiple output amplifier 210 includes EDFA 112 and optical splitter 114, both of which are configured in the same manner as with high-power, multiple output amplifier 110.

In accordance with the present invention, high-power, multiple output amplifier 210 additionally includes a corresponding number of 1:2 switches SW1-SWn that are connected to the outputs of optical splitter 114. As shown, each of the switches SW1-SWn has a laser beam input LBI that receives one of the amplified modulated laser beams ALB1-ALBn.

In addition, each of the switches SW1-SWn has a first laser beam output RB1 that is connected to a corresponding optical fiber section OF1-OFn, and a second laser beam output RB2. Each of the switches SW1-SWn also has a control input CI that receives a control signal CS such that the switches SW1-SWn receive a corresponding number of control signal CS1-CSn.

As further shown in FIG. 2, amplifier 210 includes a corresponding number of optical terminators OT1-OTn that are connected to the second laser beam outputs RB2 of the switches SW1-SWn. In the present invention, an optical terminator OT is defined to be a device that absorbs all of the optical energy for a channel, allowing none to be reflected back to EDFA 112.

In operation, high-power, multiple output amplifier 210 receives the modulated laser beam MLB, and amplifies and splits the modulated laser beam into the amplified modulated laser beams ALB1-ALBn in the same manner as amplifier 110. As a result, the laser beam input LBI of each of the switches SW1-SWn receives one of the amplified modulated laser beams ALB1-ALBn.

The logic state of the control signal CS received by each of the switches SW1-SWn determines whether the amplified modulated laser beam ALB is passed to the first laser beam output RB1 or the second laser beam output RB2. In normal operation, the logic states of the control signals CS1-CSn are set so that the switches SW1-SWn pass the received amplified modulated laser beams ALB1-ALBn to the corresponding optical fiber sections OF1-OFn.

The logic states of the control signals CS1-CSn can be set, for example, by utilizing manually-operated, electrical or mechanical toggle switches or microprocessor control. Microprocessor control, in turn, can be provided, for example, via commands entered from a command line interface, or via commands entered from an Ethernet Telnet/HTTP interface.

In accordance with the present invention, when maintenance is required to repair or clean fiber or equipment that lies downstream of an output of high-power, multiple output amplifier 210, the logic state of the control signal CS that corresponds with the switch SW that passes a laser beam to the output is changed to pass the laser beam to an optical terminator.

For example, if maintenance needs to be provided to fiber optic section OF1, the logic state of control signal CS1 is changed so that switch SW1 passes the amplified modulated laser beam ALB1 to optical terminator OT1, which absorbs all of the optical energy of the amplified modulated laser beam ALB1, allowing none to be reflected back to EDFA 112.

Similarly, if maintenance needs to be provided to both the fiber optic section OF2 and the local fiber LF1 that is connected to splitter SP1, the logic states of the control signals CS1 and CS2 are changed so that switches SW1 and SW2 pass the amplified modulated laser beams ALB1 and ALB2, respectively, to optical terminators OT1 and OT2, respectively. Thus, multiple sections of the fiber can be disabled at the same time.

In both of these examples, the logic states of the control signals CS that are connected to the remaining switches SW remain unchanged, allowing the amplified modulated laser beams ALB to continue to pass on to the subscribers. As a result, when maintenance needs to be provided, the present invention allows service to be cut to only those subscribers that receive a signal from amplifier 210 via the output that is associated with the maintenance.

Once the logic state of a control signal CS has been changed and the corresponding optical terminator OT receives the amplified modulated laser beam ALB, the fiber or equipment requiring maintenance can be safely disconnected from the network (PON 200). When maintenance is complete, the fiber or equipment can then be reconnected to the network (PON 200).

After being reconnected to the network, the logic state of the control signal CS is changed so that the amplified modulated laser beam ALB is again passed to the corresponding optical fiber section OF, thereby restoring the service to the subscribers that was lost during the maintenance period.

Thus, one of the advantages of the present invention is that the vast majority of subscribers that receive a signal from high-power, multiple output amplifier 210 can continue to receive service during the maintenance period. As a result, the present invention significantly improves the quality of service that an operator can provide to their subscribers.

In addition to improving the quality of service to the subscribers, another advantage of the present invention is that the present invention provides a method of easily removing power from a high power amplifier. Providing a method of easily removing power increases the likelihood that maintenance procedures will be followed, thereby improving safety by reducing the likelihood of inadvertent eye damage that can occur from working with a “live” fiber.

It should be understood that the above descriptions are examples of the present invention, and that various alternatives of the invention described herein may be employed in practicing the invention. For example, although the FIG. 2 example shows all of the optical fiber sections OF connected to the local splitters SP, one or more, including all, of the optical fiber sections OF1-OFn can alternately be connected directly to ONTs at the subscribers' premises.

Further, PON 200 can include a number of high-power, multiple output amplifier 210 that lie between the optical line terminal (OLT) and a subscriber's premise. Thus, it is intended that the following claims define the scope of the invention and that structures and methods within the scope of these claims and their equivalents be covered thereby.

What is claimed is:

1. A high-power, multiple output amplifier comprising:
a light amplifier that amplifies an intensity of a modulated laser beam to form an intensified modulated laser beam; and
an optical splitter that receives the intensified modulated laser beam, and then splits the intensified modulated laser beam to output a plurality of amplified modulated laser beams.

2. The high-power, multiple output amplifier of claim 1 and further comprising a plurality of switches that are connected to the optical splitter to receive the plurality of amplified modulated laser beams.

3. The high-power, multiple output amplifier of claim 2 wherein each switch has a light input, a control input, a first output, and a second output.

4. The high-power, multiple output amplifier of claim 3 and further comprising a plurality of optical terminators that are connected to the plurality of switches such that an optical terminator is connected to the second output of each switch.

5. The high-power, multiple output amplifier of claim 4 wherein the optical terminator absorbs light that is received.

6. The high-power, multiple output amplifier of claim 5 wherein none of the light is reflected back to the light amplifier.

7. An optical network, the optical network comprising a high-power, multiple output amplifier, the high-power, multiple output amplifier comprising:
a light amplifier that amplifies an intensity of a modulated laser beam to form an intensified modulated laser beam;
an optical splitter that receives the intensified modulated laser beam, and then splits the intensified modulated laser beam to output a plurality of amplified modulated laser beams;
a plurality of switches that are connected to the splitter to receive the plurality of amplified modulated laser beams;
a plurality of optical fiber sections that are connected to the plurality of switches; and
a plurality of optical terminators that are connected to the plurality of switches.

8. The optical network of claim 7 and further comprising a plurality of local splitters connected to the plurality of optical fiber sections.

9. The optical network of claim 8 and further comprising:
a plurality of local fiber sections that are connected to the plurality of local splitters; and
a plurality of optical network terminals connected to the plurality of local fiber sections, and to a corresponding plurality of subscriber premises.

10. The optical network of claim 7 and further comprising a plurality of optical network terminals connected to a plurality of the optical fiber sections, and to a corresponding plurality of subscriber premises.

11. A method of maintaining a passive optical network, the passive optical network including a high-power, multiple output amplifier, the amplifier comprising:
a light amplifier that amplifies an intensity of a laser beam; and
an optical splitter that splits a laser beam,
the method comprising the steps of:
receiving a modulated laser beam;
intensifying the modulated laser beam with the light amplifier to form an intensified modulated laser beam; and
splitting the intensified modulated laser beam to output a plurality of amplified modulated laser beams.

12. The method of claim 11 wherein the high-power, multiple output amplifier further comprises a plurality of switches that are connected to the splitter to pass the plurality of amplified modulated laser beams, the plurality of switches receiving a plurality of control signals, the plurality of control signals each having first and second logic states.

13. The method of claim 12 and further comprising the steps of:
determining a switch of the plurality of switches that passes an amplified modulated laser beam to a section of the passive optical network to be maintained; and
changing a logic state of the control signal received by the switch from a first logic state to a second logic state to remove the amplified modulated laser beam from the section of the passive optical network to be maintained.

14. The method of claim 13 and further comprising the step of determining a plurality of remaining switches that pass amplified modulated laser beams to other sections of the passive optical network, the logic states of the control signals received by the remaining switches being set to the first logic states.

15. The method of claim 14 and further comprising the step of changing the logic state of the control signal received by the switch from the second logic state to the first logic state to restore the amplified modulated laser beam from the section of the passive optical network after the repair has been completed.

16. The method of claim 14 wherein the high-power, multiple output amplifier further comprises a plurality of optical terminators that are connected to the plurality of switches such that an optical terminator is connected to each switch.

17. The method of claim 16 wherein the optical terminator absorbs the amplified modulated laser beam when the amplified modulated laser beam is removed from the section of the passive optical network to be maintained.
